(19) United States
(12) Patent Application Publication
(10) Pub. No.: US 2016/0366001 A1
(43) Pub. Date: Dec. 15, 2016

(54) Receiver identification by encoder state

(71) Applicant: Intel IP Corporation, Santa Clara, CA (US)

(72) Inventors: Qinghua Li, San Ramon, CA (US); Xiaogang Chen, Beijing (CN); Yuan Zhu, Beijing (CN); Huaning Niu, Milpitas, CA (US); Jeongho Jeon, San Jose, CA (US)

(73) Assignee: Intel IP Corporatio, Santa Clara, CA (US)

(21) Appl. No.: 14/998,280

(22) Filed: Dec. 24, 2015

Related U.S. Application Data
(60) Provisional application No. 62/173,776, filed on Jun. 10, 2015.

(51) Int. Cl. H04L 27/26

(52) U.S. Cl. CPC H04L 27/2626; H04L 27/2607

(57) ABSTRACT

This disclosure describes methods, apparatus, and systems related to receiver identification. A device may identify a data frame received from a first device, the data frame including one or more data fields. The device may decode the one or more data fields in the identified data frame using tail biting decoding having an initial decode state and an end decode state. The device may determine the received data frame is intended for the device based at least in part on the decoded one or more data fields.

### CROSS-REFERENCE TO RELATED APPLICATIONS

This application claims the benefit of U.S. Provisional Application No. 62/173,776 filed Jun. 10, 2015 the disclosure of which is incorporated herein by reference as if set forth in full.

### TECHNICAL FIELD

This disclosure generally relates to systems and methods for wireless communications and, more particularly, to sending a receiver identification by encoder state.

### BACKGROUND

Devices may communicate with each other in accordance to one or more communications standards, such as LTE, Wi-Fi, etc. A device may decode identification information encoded in a received message. The identification information may indicate whether the message was intended for the device.

### BRIEF DESCRIPTION OF THE DRAWINGS

FIG. 1 depicts a network diagram illustrating an example network environment of illustrative receiver identification architecture, in accordance with the one or more embodiments of the disclosure.

FIG. 2A depicts an illustrative state diagram for a receiver identification system, in accordance with one or more embodiments of the disclosure.

FIG. 2B depicts an illustrative state diagram for a receiver identification system, in accordance with one or more embodiments of the disclosure.

FIG. 3 depicts an illustrative state diagram for a receiver identification system, in accordance with one or more embodiments of the disclosure.

FIG. 4 depicts an illustrative state diagram for a receiver identification system, in accordance with one or more embodiments of the disclosure.

FIGS. 5A-5C depict illustrative starting and ending states for a receiver identification system using a cyclic redundancy check (CRC), in accordance with the one or more embodiments of the disclosure.

FIG. 6A depicts a flow diagram of an illustrative process for illustrative receiver identification architecture, in accordance with one or more embodiments of the disclosure.

FIG. 6B depicts a flow diagram of an illustrative process for illustrative receiver identification architecture, in accordance with one or more embodiments of the disclosure.

FIG. 7 illustrates a functional diagram of an example communication station that may be suitable for use as a user device, in accordance with one or more example embodiments of the disclosure.

FIG. 8 is a block diagram of an example machine upon which any of one or more techniques (e.g., methods) may be performed, in accordance with one or more embodiments of the disclosure.

### DETAILED DESCRIPTION

Example embodiments described herein provide certain systems, methods, and devices, for providing a framework for flexible connectivity between wireless devices.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In a wireless system such as LTE and Wi-Fi, the transmission of identification information such as a receiver's address consumes significant overhead in headers of data packets during communication between two or more devices. In some instances, the overhead used by the identification information may be a significant number of bits. For example, in Wi-Fi, the access ID (AID) of a receiving device may be around 11 bits, and the media access control address (MAC) may be around 48 bits. In LTE, the identification information may even more.

Example embodiments of the present disclosure relate to systems, methods, and devices for a receiver identification system that facilitates encoding/decoding identification information (ID) associated with a receiving device or other identification information. An encoder, such as a convolutional encoder, may encode data before transmission from a transmitting device to a receiving device. The encoder may utilize a state diagram in order to traverse through various states during encoding of data packets before transmission to another device. A state diagram may comprise predetermined set of states and corresponding conditional event driven transitions between one or more of the states. Convolutional encoding is commonly specified by three parameters, number of input bits, number of output bits, and number of memory registers. The output bits may be produced by adding certain bits in the memory registers. The selection of bits to be added to produce the output bits may be determined by a polynomial. For each input bit, there may be a number of output bits.

In one embodiment, the identification information, such as, a receiving device's ID, a cell ID, a base station ID, an access ID, a connection ID, or the like, may be used as a starting or an ending state of an encoder, such as a convolutional encoder. When a data packet is received by the receiving device, the receiving device may utilize known identification information for its decoders starting state and/or ending state. For example, since each associated receiving device knows its ID information beforehand, the receiving device may use the ID as a starting state and/or an ending state for determining whether a received data packet was intended for the receiving device. This may reduce the header overhead by a few bits, resulting in better use of bandwidth and throughput since the ID information is encoded in one or more states of an encoder's state diagram.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device,” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, a user equipment (UE), a wireless communication device, or some other similar terminology known in the art. Embodiments disclosed herein generally pertain to wireless networks. Some embodiments can relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one-way and/or two-way radio communication systems, cellular radio-telephone communication systems, a mobile phone, a cellular telephone, a wireless telephone, a personal communication systems (PCS) device, a PDA device which incorporates a wireless communication device, a mobile or portable global positioning system (GPS) device, a device which incorporates a GPS receiver or transceiver or chip, a device which incorporates a radio frequency identification (RFID) element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MCM), discrete multi-tone (DMT), Bluetooth®, global positioning system (GPS), Wi-Fi, Wi-Max, ZigBee™, ultra-wideband (UWB), global system for mobile communication (GSM), 2G, 2.5G, 3G, 3.5G, 4G, fifth generation (5G) mobile networks, 3GPP, long term evolution (LTE), LTE advanced, enhanced data rates for GSM evolution (EDGE), or the like. Other embodiments may be used in various other devices, systems, and/or networks.

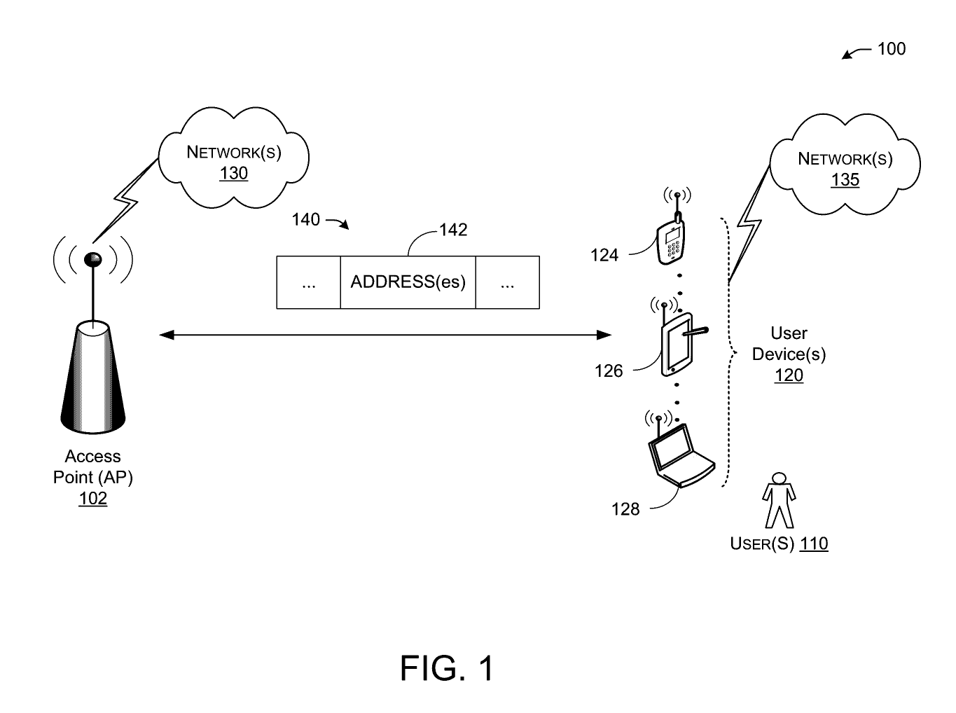

The illustrative wireless network 100 of FIG. 1 may include one or more control node (CN) 102 (e.g., AP or an LTE base station) that communicate with one or more user device(s) 120, in accordance with wireless communications standards, such as LTE and/or Wi-Fi, or the like.

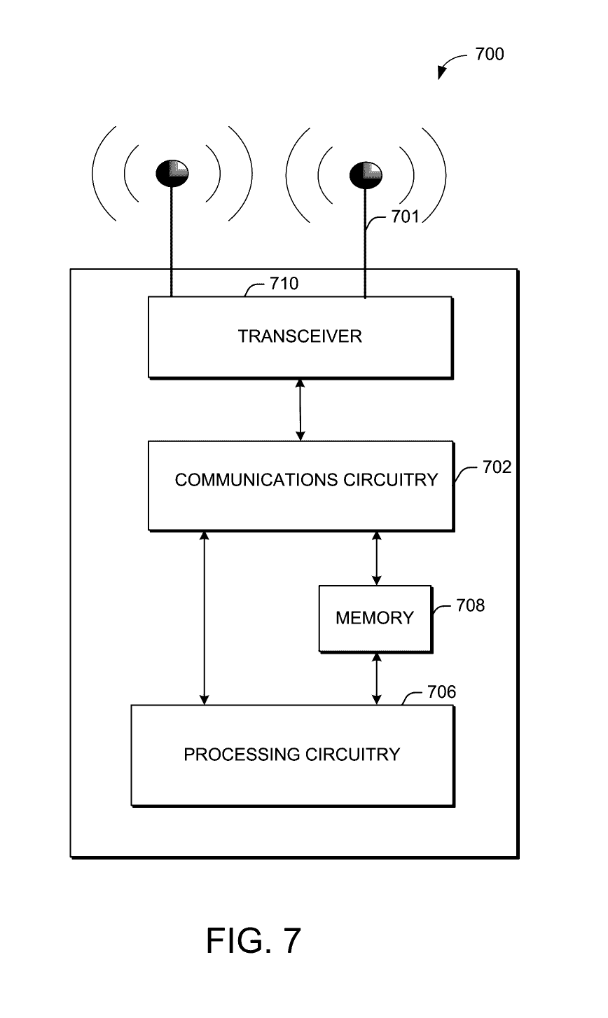

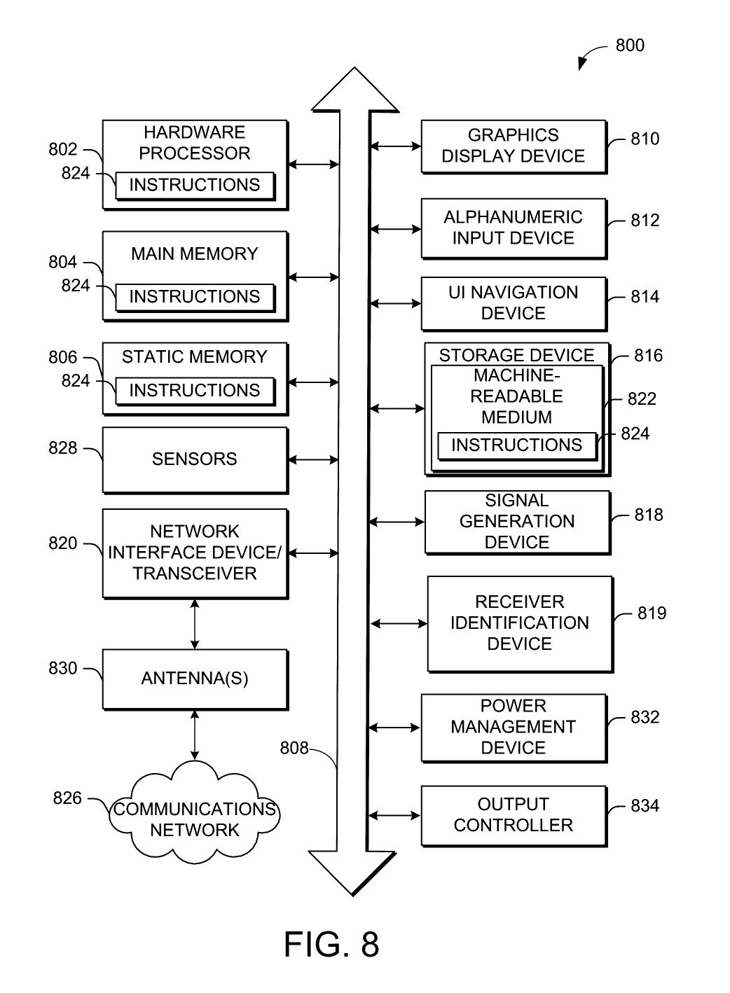

In the example of FIG. 1, the one or more user device(s) 120 and the one or more CN(s) 102 may be devices that are non-stationary without fixed locations or may be stationary with fixed locations. In some embodiments, the user device(s) 120 and CN 102 can include one or more computer systems similar to that of the functional diagram of FIG. 7 and/or the example machine/system of FIG. 8.

One or more illustrative user device(s) 120 may be operable by one or more user(s) 110. The user device(s) 120 (e.g., 124, 126, or 128) may include any suitable processor-driven user device including, but not limited to, a desktop user device, a laptop user device, a server, a router, a switch, an access point, a smartphone, a tablet, wearable wireless device (e.g., bracelet, watch, glasses, ring, etc.) and so forth. Any of the user devices 120 (e.g., 124, 126, or 128) may be configured to communicate with each other and any other component of the wireless network 100 via one or more communications networks 130 and/or 135 wirelessly or wired.

Referring to FIG. 1, any of the user devices 120 and/or CN 102 may communicate with each other by transmitting and receiving data on a communications channel. During the communication, various identification information may be exchanged between the devices in order to determine, for example, whether the receiving device is the intended receiving device based at least in part on the identification information.

Any of the user device(s) 120 (e.g., user devices 124, 126, 128), and CN 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and CN 102 may include one or more communications antennae. Communications antenna may be any suitable type of antenna corresponding to the communications protocols used by the user device(s) 120 (e.g., user devices 124, 124 and 128), and CN 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and CN 102 may include any suitable radio and/or transceiver for transmitting and/or receiving radio frequency (RF) signals in the bandwidth and/or channels corresponding to the communications protocols utilized by any of the user device(s) 120 and CN 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11 ax), 5 GHz channels (e.g. 802.11n, 802.11 ac, 802.11 ax), or 60 GHZ channels (e.g. 802.11 ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Typically, when a CN (e.g., CN 102) establishes communication with one or more user devices 120 (e.g., user devices 124, 126, and/or 128), CN 102 may communicate in the downlink direction and the user devices 120 may communicate with the CN 102 in the uplink direction by sending data frames in either direction. The data frames exchanged between the devices may be preceded by preambles that may be part of headers. Headers may include one or more identifying information, such as address fields, frame control, frame type, subtype, or other identifying information. A header may be a signal used in network communications to synchronize transmission timing between two or more devices (e.g., between the CNs and user devices).

In one embodiment, and with reference to FIG. 1, a header (e.g., header 140) may include one or more address fields 142 or other identifying information. It is understood that the above structure of the header may vary based on the communication standard (e.g., LTE, Wi-Fi, CDMA, etc.).

In one embodiment, when a CN 102 prepares the header 140 for transmission to a user device 120, the CN 102 may encode the data using various encoders, for example, a convolutional encoder. The convolutional encoder may utilize a state diagram for encoding. The receiver identification system may encode identification information into one or more states of the convolutional encoder. Identification information may include a receiving device's ID, a cell ID, a base station ID, an access ID, a connection ID, or the like. Identification information may be used as a starting state and/or an ending state by an encoder, such as a convolutional encoder. A convolutional encoder may have a starting state and an ending state in its state diagram. Since each associated receiving device (e.g., user device 120) knows its ID beforehand, the transmitting device, such as CN 102, may utilize that information when encoding using the convolutional encoder. For example, the encoder of CN 102 may use the starting state to contain identification information of the user device 120. When the user device 120 receives the encoded data, it may decode the data using a decoder. The user device 120 may use its own ID to initialize the decoding state of its decoder as a starting state and/or an ending state. If the data was intended for this user device 120, then the decoding using that starting and/or ending state may be successful. However, if the decoding using that starting and/or ending states was unsuccessful, the user device 120 may determine that the message was not intended for it. Having the user device 120 use identification information as starting and/or ending states in its decoding process may reduce the header overhead by a few bits, resulting in better use of bandwidth and throughput.

In other embodiments, the starting and/or ending states may be set to be the same during the encoding process on a transmitting device. For example, if a receiver's identification information is used for the starting state of the encoder, then that same information may also be found in the ending state of the decoder. The receiving device may be aware that the transmitting device utilized the mechanism of having the starting state and the ending state being the same. Consequently, knowing that mechanism (e.g., having the starting state and ending state contain the same identification information), the receiving device may set the decoding starting state and/or ending state to be the same during the decoding process of data packets received by the receiving device.

It is understood that the receiving device may be aware of the encoding mechanism used by the transmitting device. That is, whether the starting state and/or the ending state or other states include at least part of the identification information of the receiving device or other identification information. For example, if the transmitting device determines that the encoding mechanism includes setting the identification information in the starting state of the encoder, and setting the ending state of the encoder to zeros, the receiving device may be made aware of that encoding mechanism. Details of which mechanism was used by the transmitting device may be exchanged with the receiving device using one or more messages, or may be set in as part of the communications standard used by the receiving device and/or the transmitting device, or may be set by a network/system administrator.

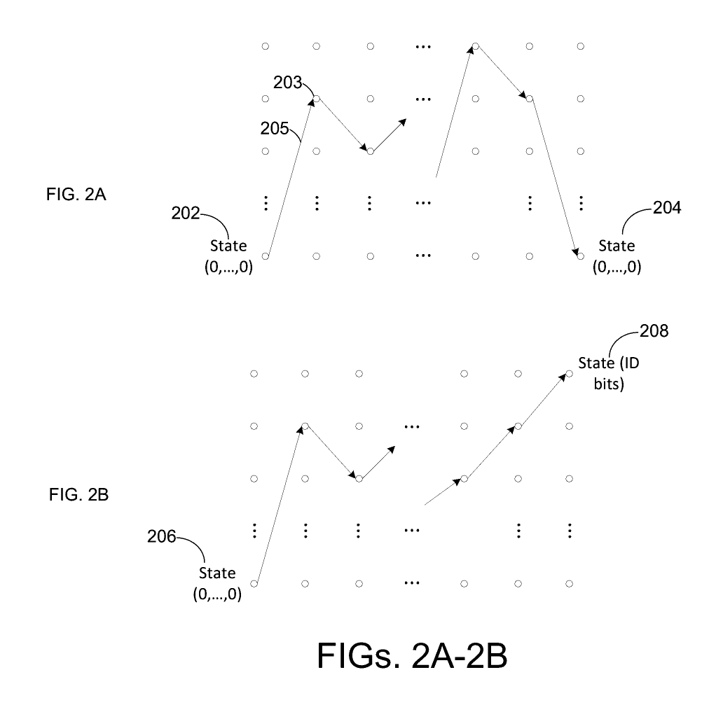

FIG. 2A depicts an illustrative state diagram for a receiver identification system, having a starting and an ending state. A state diagram may represent a series of events that may occur between one or more possible states. An encoder may utilize the one or more states in the state diagram to encode data for transmission to a receiving device. The encoder may start at a starting state (e.g., state 202), and may terminate at an ending state (e.g., state 204). The state diagram may represent the behavior of the encoder within a finite number of states (e.g., state 203). The path from one state to another is represented by path(s) 205, showing that an encoder may move from a first state to a second state. In the example of FIG. 2A, the encoder starts from state 202 and terminates at state 204 by passing through multiple states 203, shown by path(s) 205. For example, the starting state 202 may be initialized to a zero state (having multiple zero bits). The ending state 204 may be also set to a zero state. For terminating at zero state, the tail bits (e.g., six zero bits for Wi-Fi) may need to be inputted to the encoder. The corresponding output codebits for the tail bits may need to be sent for protecting the last few information bits. Therefore, overhead is incurred by the tail bits. Tail biting may indicate that the starting and ending states are the same so that no tail bits are needed. However, the starting and ending state may be unknown to the receiving device. The uncertainty may degrade the performance by about 1-2, because the receiving device has to decode the data frames before realizing whether the message is intended for it or not.

FIG. 2B depicts an illustrative state diagram for a receiver identification system, in accordance with one or more embodiments of the disclosure.

In one embodiment, the receiving device's ID information, cell ID, base station ID, access ID, connection ID, or the like may be used as the starting or ending state to improve performance, since the receiving device knows its own ID information when analyzing received data packets, it may determine whether it was the intended recipient of these data packets. For example, as shown in FIG. 2B, the initial state 206 may be set to a zero state and the ending state 208 may be set to a receiving device's ID or other identification information known to the receiving device. Besides receiving device ID or address, any bits known by the transmitting device and/or the receiving device may be used to set the starting and/or the ending states of the convolutional encoder. In this case, since the receiving device is aware of these known bits that were used during the encoding process at the transmitting device, the receiving device may confirm the reception of the known bits by decoding the relative states of the decoder.

In the example of FIG. 2B, the transmitting device may use some of the receiving device's ID bits as the tail bits to end the encoding process. As compared to the conventional convolutional code in FIG. 2A, no additional tail bits (e.g. 6 bits) are inputted to flush the ID bits in the encoder registers. Therefore, the overhead may be improved for sending the codebits of the tail bits because the tail bits and the corresponding codebits are already known to the intended receiving device beforehand. As long as the starting and the ending states (e.g. zero state and ID bits) are known to the intended receiving device, the performance of the new code may be similar to that of the convolutional code with tail bits.

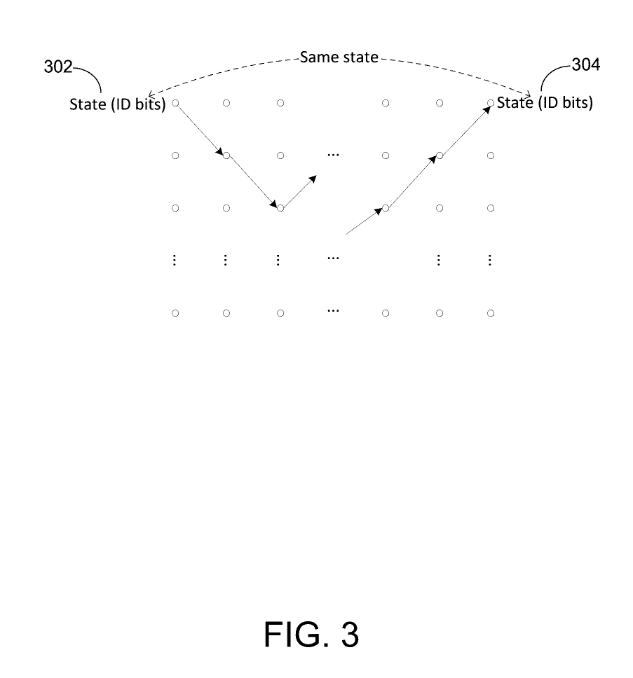

FIG. 3 depicts an illustrative state diagram for a receiver identification system, in accordance with one or more embodiments of the disclosure.

In some embodiment, a starting state (e.g., state 302) and an ending state (e.g., state 304) may be encoded with a receiving device's identification information or other known identifications by the receiving device. During a communication between two or more devices, for example, between a CN 102 (FIG. 1) and a user device 120 (FIG. 1), data packets may be sent and received. However, in certain scenarios, unintended receiving devices may receive these data packets over the air. In that scenario, the unintended receiving device may need to decode the received data packets. An example of the unintended receiving device may be a sniffer, which may be a device used between the one or more devices to collect data sent and received for testing and debugging purposes. When the sniffer receives the unintended data packets, the sniffer may still need to decode the data packets received over the air to determine whether these data packets belong to it or not. Following this mechanism, in order to decode data packets received at a receiving devices antenna, the sniffer may set the starting and ending states (e.g., states 302 and 304, respectively) of the decoder using known bits such as its ID bits in order to decode the received data packets. Various known identification information may be used as a starting and ending states, such as, receiving device's ID, cell ID, base station ID, access ID, connection ID, etc. The sniffer device may fail by first looking at the starting state 302 because the incorrect ID may be used for that starting state, as the sniffer was not the intended receiving device. However, this may not be the end of the decoding process since many reasons may have contributed to the starting state being wrongly decoded, for example interference or errors in decoding. The sniffer may continue its decoding process and may use the knowledge that the starting state 302 and ending state 304 are the same. Essentially, the unintended receiving device may use the decoding method for tail biting convolutional code, which assumes any state can be a valid state for the starting state and the ending state. Therefore, the sniffer may still decode the data packets with a degraded performance, which may be around 1-2 dB worse than conventional convolutional code.

In some embodiments, the starting state 302 and the ending state 304 may not need to be the same. The two states may be related by any one-to-one mapping. For example, S_{ending}=(S_{starting}+C) mod Nₛₜₐₜₑ, where S_{ending} and S_{starting} are the ending and starting states in decimal presentation (e.g. (1,0,1)=5), Nₛₜₐₜₑ is the total number of states (e.g., 64), and C is a constant known to the receiving device. For example, when C=0, the starting and the ending states are the same. It is understood that the above is only an example and that other ways to relate the starting state and the ending state may be employed.

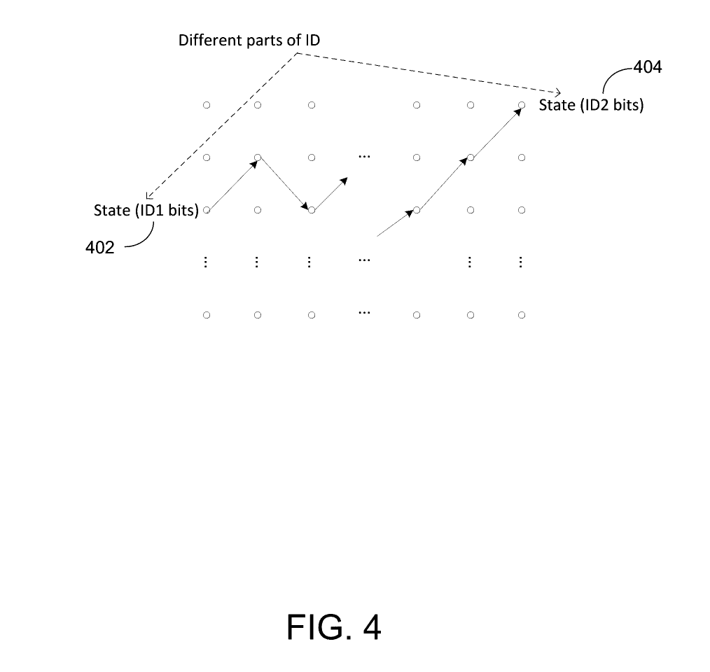

FIG. 4 depicts an illustrative state diagram for a receiver identification system, in accordance with one or more embodiments of the disclosure.

In one embodiment, the starting state (e.g., state 402), and the ending state (e.g., state 404) on a state diagram may contain the ID bits of the identification information (e.g., receiving device's ID, cell ID, base station ID, access ID, connection ID, etc.). For example, since a device ID is usually longer than the bit length of a state index, both the starting state 402 and the ending state 404 may be used to carry the ID bits as shown in FIG. 4. In that sense, the decoder of the receiving device (e.g., user devices 120 and/or CN 102 of FIG. 1) may know to set its starting state and its ending state to a division of the ID bits as agreed upon between a transmitting device and the receiving device at earlier stages. This may be done by messaging between the transmitting and the receiving device or by the communications standard used by the transmitting and receiving devices or by a network/system administrator. For example, the encoder of the transmitting device may use a predetermined division of the identification information between the starting state 402 and the ending state 404. The decoder of the receiving device may be aware of that predetermined division of the identification information before starting to decode any of the received data packets. For example, the first 6 bits of identification information (e.g., receiving device ID, cell ID, base station ID, access ID, or connection ID) may be used to set the starting states of the encoder and the decoder and the last 6 bits may be used to set the ending states of the encoder and the decoder. The identification information may be used to set the ending state of the encoder and decoder. Since the ID bits are known to the intended receiving device, the intended receiving device may set the states using the corresponding bits properly for decoding. That is, the receiving device may know that the first 6 bits of the identification information are set as a starting state of the decoder and the last 6 bits of the identification information are set for the ending state of the decoder. It is understood that the above example is only for illustrative purposes and that other division of the identification information between the starting state and the ending state may be used.

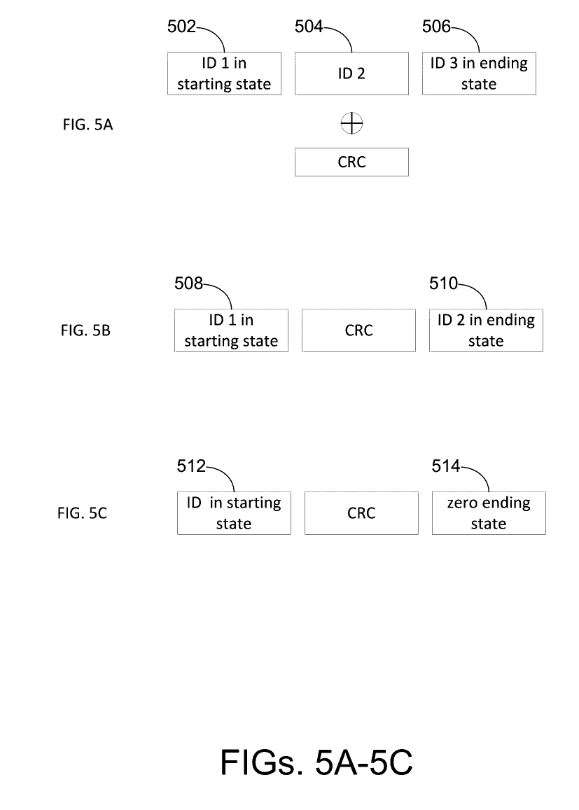

FIGS. 5A-5C depict illustrative starting and ending states for a receiver identification system using a cyclic redundancy check (CRC), in accordance with the one or more embodiments of the disclosure.

In one embodiment, identification information bits known to the transmitting device (e.g., CN 102 and/or user devices 120 of FIG. 1) may be used for setting the starting state and/or ending state of the channel coding by using a masking technique with a cyclic redundancy check (CRC). The identification information bits may be larger than what can be accommodated in the available starting state and ending state. As can be seen in FIG. 5A, the identification information bits may be divided into multiple groups, for example, group 502, group 504, and group 506. The identification information bits in group 502 may be encoded in the starting state, the identification information bits in group 504 may be masked with the CRC, and the identification information in group 506 may be encoded in the ending state of the encoder. The same is true at the decoder of the receiving device. That is, the receiving device would know how many bits of the identification information are in the starting state, masked with the CRC, and in the ending state in order to properly decode the received data packets.

In one embodiment, if there are not enough ID bits available for the starting and ending states to carry, padding with known bits may be used. For example, if the identification information bits are 20 bits, three different subsets of the 20 bits may be generated (e.g., ID 1, ID 2, and ID 3). In this example, ID 1, ID 2, and ID 3 may have 6, 8, and 6 bits, respectively. ID 1 and ID 3 may be used to set the starting and ending states, respectively (e.g., groups 502 and 506). ID 2 may be masked by a CRC bit sequence with 8 bits, where the masking operation may be a bit-wise exclusive OR gate (e.g., XOR gate). It is understood that the masking of the ID 2 using CRC and the XOR gate is for illustrative purposes only and that other operations may be performed in order to mask the portion of the identification information (e.g., ID 2) for encoding and decoding purposes.

Referring to FIG. 5B, there is shown an example where CRC masking may not be needed. In that example, if the identification information bits fit the starting state 508 and/or ending state 510, it may not be necessary to split the identification information bits into more than two groups. Consequently, CRC may not be needed to mask any identification information bits or only partially mask some identification information bits.

Referring to FIG. 5C, padding may be used in one of the starting state and/or the ending state. For example, if the identification information is short enough to fit into one of the starting state and/or the ending state, padding zeros may be used in one of the starting state and/or the ending state. In FIG. 5C, the identification information may fit into starting state 512, and the ending state 514 may be padded with zeros. In some embodiments, if the starting state and/or ending state have more space than the identification information bits, the rest of the state may be padded with zero. For example, if the starting state 512 has room for 10 bits, but the identification information is only 6 bits, then the other 4 bits of the starting state 512 may be padded with zeros.

It is understood that in addition to headers, the above embodiments and techniques may be applied to data portion as well. For example, for the data portion, the transmitter may use the receiver's ID bits to set the starting state and/or ending state of the convolutional code.

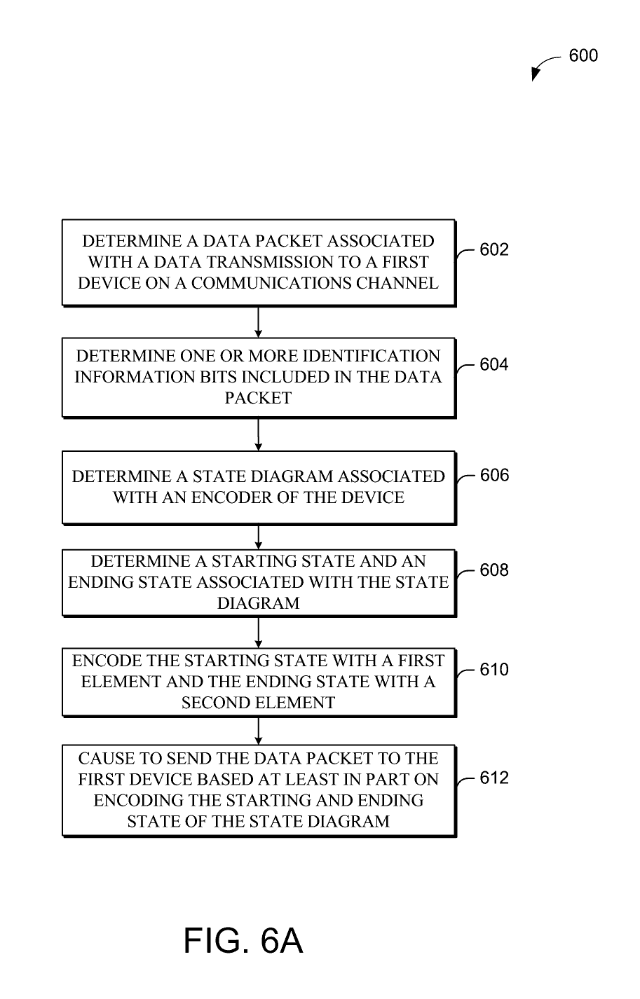

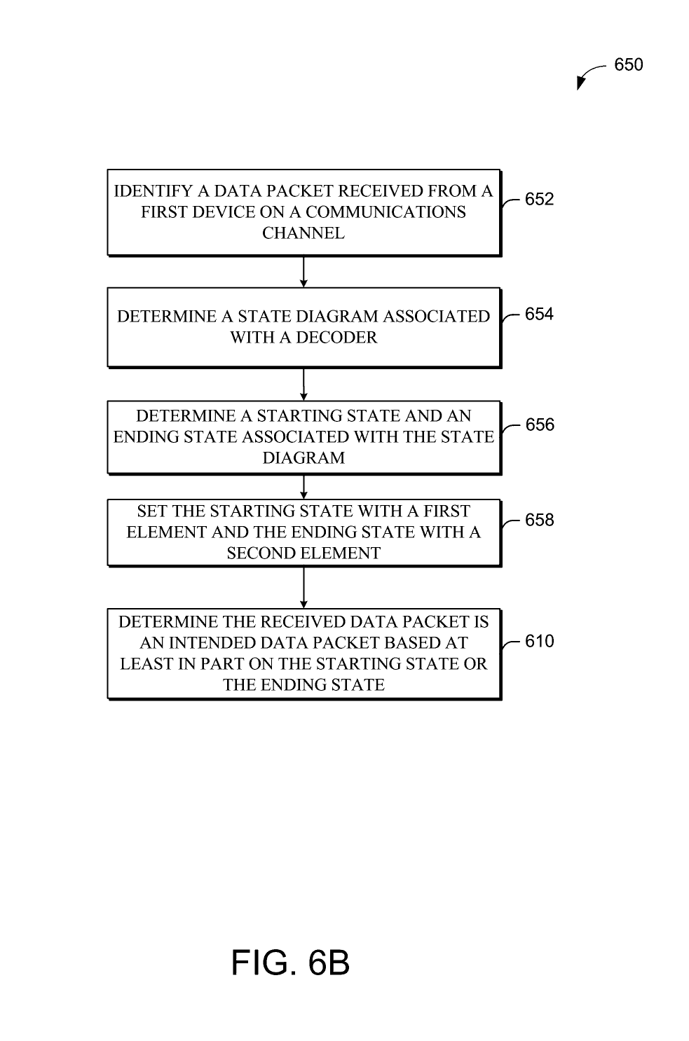

FIG. 6A depicts a flow diagram of an illustrative process 600 for an illustrative receiver identification system, in accordance with one or more embodiments of the disclosure.

At block 602, a device (e.g., CN 102 and/or user devices 120 of FIG. 1) may be a transmitting device and may determine a data packet to be sent to another device (e.g., CN 102 and/or user devices 120 of FIG. 1) that may be a receiving device, on a communications channel. The communication channel may be in accordance to communications standards, such as, LTE, Wi-Fi, CDMA, etc. It is understood that the transmitting device may be a receiving device and the receiving device may be a transmitting device.

At block 604, the device may determine one or more identification information bits included in the data packet. For example, a header associated with the data packet may contain one or more address associated with the transmitting device and/or the receiving device. The one or more identification information may include one or more of the receiving device's ID, a cell ID, a base station ID, an access ID, a connection Ill, etc.

At block 606, the device may determine a state diagram associated with an encoder of the device. The encoder may be a convolutional encoder. A convolutional encoder may be used to encode data before transmission from a transmitting device to a receiving device. Convolutional encoding is commonly specified by three parameters, number of input bits, number of output bits, and number of memory registers. The state diagram may include multiple states that may be traversed from one state to another. The state diagram may represent the behavior of the encoder within a finite number of states.

At block 608, the device may determine a starting state and an ending state associated with the state diagram. The encoder may start encoding by starting at the starting state and then traversing through the encoding until reaching the ending state. In some examples, the starting state and the ending state may be set to be the same.

At block 610, the device may encode the starting state with a first element and the ending state with a second element. The first element may be a first set of bits associated with the one or more identification information bits. The second element may be a second set of bits associated with the one or more identification information bits. For example, a receiving device's ID (cell ID, base station ID, access ID, connection ID, etc.) may be used as starting and/or ending state while using an encoder (e.g., a convolutional encoder). Since each associated receiving device knows its ID beforehand, the receiving device may use the ID to initialize the starting state or the ending state while decoding the data packet. This may reduce the header overhead by a few bits, resulting in better use of bandwidth and throughput. In another example, the first element may be a subset of bits of the one or more identification information bits, while the second element may be the rest of the one or more identification information bits. In that sense, the one or more identification information bits may be split or divided between the first element and second element. The encoder would then set the starting and ending states with the entirety of the one or more identification information bits. The receiving device would then utilize that knowledge when decoding the received data packet. In further other examples, the one or more identification information bits may be larger than what the starting state and the ending state of the state diagram can accommodate. In that case, a first portion of bits of the one or more identification information bits may occupy the starting state, a second portion of bits of the one or more identification information bits may be masked with a cyclic redundancy check (CRC) associated with the data packet, and a third portion of the one or more identification information bits may occupy the ending state. The second portion of the one or more identification information bits may be masked with the CRC using an exclusive OR gate (XOR). It is understood that above are only example of dividing the one or more identification information bits into various states. In some other examples, the one or more identification information bits may occupy less than the size of the starting or the ending states. In that case, padding may be utilized, for example, padding with zeros in the starting or ending states.

At block 612, the device may cause to send the data packet to the receiving device based at least in part on encoding the starting and ending state of the state diagram.

FIG. 6B depicts a flow diagram of an illustrative process 650 for an illustrative receiver identification system, in accordance with one or more embodiments of the disclosure.

At block 652, a receiving device (e.g., CN 102 and/or user devices 120 of FIG. 1) may identify a data packet received from a transmitting device (e.g., CN 102 and/or user devices 120 of FIG. 1) on a communications channel. It is understood that the transmitting device may be a receiving device and the receiving device may be a transmitting device.

At block 654, the receiving device may determine a state diagram associated with a decoder that may be used to decode the received data packet. The decoder may be a convolutional decoder.

At block 656, the receiving device may determine a starting state and an ending state associated with the state diagram. In some examples, the starting state and the ending state may be the same. The decoder may begin decoding the data packet at the starting state and then traverse through the decoding until reaching the ending state. The receiving device may be aware of how the transmitting device encoded the data packet. This may have been agreed upon at earlier stages between the transmitting device and the receiving device.

At block 658, the receiving device may set the starting state with a first element and the ending state with a second element. For example, the receiving device's ID (cell ID, base station ID, access ID, connection ID, etc.) may be used as a starting and/or an ending state while using the decoder. Since each associated receiving device knows its ID beforehand, the receiving device may use the ID to initialize its decoder's starting state or use the ID as its decoder's ending state when decoding the received data packets. In another example, the first element may be a subset of bits of the one or more identification information bits, while the second element may be the rest of the one or more identification information bits. In that sense, the one or more identification information bits may be split or divided between the first element and second element. The decoder would then set the starting and ending states by dividing the identification information bits between the starting state and the ending state. The receiving device would then utilize that knowledge when decoding the received data packet. In further other examples, the one or more identification information bits may be larger than what the starting state and the ending state of the state diagram could accommodate. In that case, a first portion of the one or more identification information bits may occupy the starting state, a second portion of the one or more identification information bits may be masked with a cyclic redundancy check (CRC) associated with the data packet, and a third portion of the one or more identification information bits may occupy the ending state. The second portion of the one or more identification information bits may be masked with the CRC using an exclusive OR gate (XOR). It is understood that above are only example of dividing the one or more identification information bits into various states. In some other examples, the one or more identification information bits may occupy less than the size of the starting or the ending states. In that case, padding may be utilized, for example, padding with zeros in the starting or ending states.

At block 660, the receiving device may determine the received data packet is an intended data packet based at least in part on the starting state or the ending state. In case the data packet was determined to be unintended for this particular receiving device, the unintended receiving device may either continue decoding the data packet or may stop decoding. For example, in the case where the starting state and the ending state are the same, and if the receiving device fails to determine that the starting state contains the expected identification information, the receiving device may continue its decoding process and may use the knowledge that the starting state and ending state 304 are the same. Therefore, the receiving device may still be able to determine that ending state contains the expected identification information bits. It is understood that the above is only an example and that other examples may be used to determine whether the receiving device was the intended recipient for the data packet.

FIG. 7 shows a functional diagram of an exemplary communication station 700 in accordance with some embodiments. In one embodiment, FIG. 7 illustrates a functional block diagram of a communication station that may be suitable for use as an CN 102 (FIG. 1) or a user device 120 (FIG. 1) in accordance with some embodiments. The communication station 700 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 700 may include communications circuitry 702 and a transceiver 710 for transmitting and receiving signals to and from other communication stations using one or more antennas 701. The communications circuitry 702 may include circuitry that can operate the physical layer communications and/or medium access control (MAC) communications for controlling access to the wireless medium, and/or any other communications layers for transmitting and receiving signals. The communication station 700 may also include processing circuitry 706 and memory 708 arranged to perform the operations described herein. In some embodiments, the communications circuitry 702 and the processing circuitry 706 may be configured to perform operations detailed in FIGS. 2-6.

In accordance with some embodiments, the communications circuitry 702 may be arranged to contend for a wireless medium and configure frames or packets for communicating over the wireless medium. The communications circuitry 702 may be arranged to transmit and receive signals. The communications circuitry 702 may also include circuitry for modulation/demodulation, upconversion/downconversion, filtering, amplification, etc. In some embodiments, the processing circuitry 706 of the communication station 700 may include one or more processors. In other embodiments, two or more antennas 701 may be coupled to the communications circuitry 702 arranged for sending and receiving signals. The memory 708 may store information for configuring the processing circuitry 706 to perform operations for configuring and transmitting message frames and performing the various operations described herein. The memory 708 may include any type of memory, including non-transitory memory, for storing information in a form readable by a machine (e.g., a computer). For example, the memory 708 may include a computer-readable storage device may, read-only memory (ROM), random-access memory (RAM), magnetic disk storage media, optical storage media, flash-memory devices and other storage devices and media.

In some embodiments, the communication station 700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 700 may include one or more antennas 701. The antennas 701 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 700 may include one or more of a keyboard, a display, a non-volatile memory port, multiple antennas, a graphics processor, an application processor, speakers, and other mobile device elements. The display may be an LCD screen including a touch screen.

Although the communication station 700 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 700 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 700 may include one or more processors and may be configured with instructions stored on a computer-readable storage device memory.

FIG. 8 illustrates a block diagram of an example of a machine 800 or system upon which any one or more of the techniques (e.g., methodologies) discussed herein may be performed. In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environments. The machine 800 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The machine 800 may additionally include a storage device (i.e., drive unit) 816, a signal generation device 818 (e.g., a speaker), a receiver identification device 819, a network interface device/transceiver 820 coupled to antenna(s) 830, and one or more sensors 828, such as a global positioning system (GPS) sensor, compass, accelerometer, or other sensor. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

The receiver identification device 819 may be carry out or perform any of the operations and processes (e.g., processes 600 and 650) described and shown above. For example, the receiver identification device 819 may be configured to use the receiver's ID or address as a starting or ending state. Since each associated receiver knows its ID beforehand, the receiver may use the ID to initialize the decoding state or use the ID as the ending state for determining whether the receiver was the intended recipient of a received message.

While the machine-readable medium 822 is illustrated as a single medium, the term “machine-readable medium” may include a single medium or multiple media (e.g., a centralized or distributed database, and/or associated caches and servers) configured to store the one or more instructions 824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software. The operations and processes (e.g., processes 600 and 650) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “control node” (CN) as used herein may be a fixed station. A CN may also be referred to as an access point, an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a base station, a wired or wireless router, a wired or wireless modem, a video device, an audio device, an audio-video (AN) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

According to example embodiments of the disclosure, there may be a device. The device may include at least one memory that stores computer-executable instructions, and at least one processor of the one or more processors configured to access the at least one memory, wherein the at least one processor of the one or more processors is configured to execute the computer-executable instructions to communications channel. The at least one processor of the one or more processors may be configured to execute the computer-executable instructions to determine a state diagram associated with an encoder of the device. The at least one processor of the one or more processors may be configured to execute the computer-executable instructions to determine a starting state and an ending state of the state diagram. The at least one processor of the one or more processors may be configured to execute the computer-executable instructions to encode the starting state with a first element and the ending state with a second element. The at least one processor of the one or more processors may be configured to execute the computer-executable instructions to cause to send the data packet to the first device using the encoded starting state and the encoded ending state.

The implementations may include one or more of the following features. The at least one processor is further configured to execute the computer-executable instructions to determine one or more identification information bits in the data packet, wherein the first element may include a first set of bits associated with the one or more identification information bits. The starting state and the ending state are the same. The first element may include a first set of bits associated with the one or more identification information bits. The second element may include a second set of bits associated with the one or more identification information bits. The starting state and the ending state are different after being masked with different part of the one or more identification information bits. At least one portion of the one or more identification information bits may be masked with a cyclic redundancy check (CRC) associated with the data packet. The at least one portion of the one or more identification information bits may be masked with the CRC using an exclusive OR gate (XOR). The device of claim 1, further comprising a transceiver configured to transmit and receive wireless signals. The device of claim 9, further comprising an antenna coupled to the transceiver.

According to example embodiments of the disclosure, there may be a non-transitory computer-readable medium storing computer-executable instructions which, when executed by a processor, cause the processor to perform operations. The operations may include identifying a data packet received from a first device on a communications channel. The operations may include determining a state diagram associated with a decoder. The operations may include determining a starting state and an ending state associated with the state diagram. The operations may include setting the starting state with a first element and the ending state with a second element. The operations may include determining the received data packet may be an intended data packet based at least in part on the starting state or the ending state.

The implementations may include one or more of the following features. The operations may include the first element may be a first set of bits associated with one or more identification information bits. The starting state and the ending state may be the same. The decoder may be a convolutional decoder. The second element may be a second set of bits associated with the one or more identification information bits. At least one portion of the one or more identification information bits may be masked with a cyclic redundancy check (CRC) associated with the data packet. The at least one portion of the one or more identification information bits may be masked with the CRC using an exclusive OR gate (XOR).

In example embodiments of the disclosure, there may be a method. The method may include determining a data packet associated with a data transmission to a first device on a communications channel, determining a state diagram associated with an encoder of the device, determining a starting state and an ending state of the state diagram, encoding the starting state with a first element and the ending state with a second element, and causing to send the data packet to the first device using the encoded starting state and the encoded ending state.

Implementations may include one or more of the following features. The method may further include determining one or more identification information bits in the data packet, wherein the first element is a first set of bits associated with the one or more identification information bits.

The starting state and the ending state are the same. The first element is a first set of bits associated with the one or more identification information bits. The second element is a second set of bits associated with the one or more identification information bits. The starting state and the ending state are different after being masked with different part of the one or more identification information bits. At least one portion of the one or more identification information bits is masked with a cyclic redundancy check (CRC) associated with the data packet. The at least one portion of the one or more identification information bits is masked with the CRC using an exclusive OR gate (XOR).

In example embodiments of the disclosure, there may be an apparatus. The apparatus may include means for determining a data packet associated with a data transmission to a first device on a communications channel. The apparatus may include means for determining a state diagram associated with an encoder of the device. The apparatus may include means for determining a starting state and an ending state of the state diagram. The apparatus may include means for encoding the starting state with a first element and the ending state with a second element. The apparatus may include means for causing to send the data packet to the first device using the encoded starting state and the encoded ending state.

Implementations may include one or more of the following features. Operations further comprise means for determining one or more identification information bits in the data packet, wherein the first element may be a first set of bits associated with the one or more identification information bits. The starting state and the ending state are the same. The first element may be a first set of bits associated with the one or more identification information bits. The second element may be a second set of bits associated with the one or more identification information bits. The starting state and the ending state are different after being masked with different part of the one or more identification information bits. At least one portion of the one or more identification information bits may be masked with a cyclic redundancy check (CRC) associated with the data packet. The at least one portion of the one or more identification information bits may be masked with the CRC using an exclusive OR gate (XOR).

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor configured to access the at least one memory, wherein the at least one processor is configured to execute the computer-executable instructions to:
determine a data packet associated with a data transmission to a first device on a communications channel;
determine a predetermined set of states associated with an encoder of the device;
determine a starting state and an ending state of the predetermined set of states;
encode the starting state with a first element and the ending state with a second element; and
cause to send the data packet to the first device using the encoded starting state and the encoded ending state.

2. The device of claim 1, wherein the at least one processor is further configured to execute the computer-executable instructions to determine one or more identification information bits in the data packet, wherein the first element is a first set of bits associated with the one or more identification information bits.

3. The device of claim 1, wherein the starting state and the ending state are the same.

4. The device of claim 2, wherein the first element is a first set of bits associated with the one or more identification information bits.

5. The device of claim 2, wherein the second element is a second set of bits associated with the one or more identification information bits.

6. The device of claim 2, wherein the starting state and the ending state are different after being masked with different part of the one or more identification information bits.

7. The device of claim 2, wherein at least one portion of the one or more identification information bits is masked with a cyclic redundancy check (CRC) associated with the data packet.

8. The device of claim 7, wherein the at least one portion of the one or more identification information bits is masked with the CRC using an exclusive OR gate (XOR).

9. The device of claim 1, further comprising a transceiver configured to transmit and receive wireless signals.

10. The device of claim 9, further comprising an antenna coupled to the transceiver.

11. A non-transitory computer-readable medium storing computer-executable instructions which, when executed by a processor, cause the processor to perform operations comprising:
identifying a data packet received from a first device on a communications channel;
determining a predetermined set of states associated with a decoder;
determining a starting state and an ending state associated with the predetermined set of states;
setting the starting state with a first element and the ending state with a second element; and
determining the received data packet is an intended data packet based at least in part on the starting state or the ending state.

12. The non-transitory computer-readable medium of claim 11, wherein the first element is a first set of bits associated with one or more identification information bits.

13. The non-transitory computer-readable medium of claim 11, wherein the starting state and the ending state are the same.

14. The non-transitory computer-readable medium of claim 11, wherein the decoder is a convolutional decoder.

15. The non-transitory computer-readable medium of claim 12, wherein the second element is a second set of bits associated with the one or more identification information bits.

16. The non-transitory computer-readable medium of claim 12, wherein at least one portion of the one or more identification information bits is masked with a cyclic redundancy check (CRC) associated with the data packet.

17. The non-transitory computer-readable medium of claim 16, wherein the at least one portion of the one or more identification information bits is masked with the CRC using an exclusive OR gate (XOR).

18. A method comprising:
determining a data packet associated with a data transmission to a first device on a communications channel;
determining a predetermined set of states associated with an encoder of the device;
determining a starting state and an ending state of the predetermined set of states;
encoding the starting state with a first element and the ending state with a second element; and
causing to send the data packet to the first device using the encoded starting state and the encoded ending state.

19. The method of claim 18, further includes determining one or more identification information bits in the data packet, wherein the first element is a first set of bits associated with the one or more identification information bits.

20. The method of claim 19, wherein the second element is a second set of bits associated with the one or more ID information bits.
